(19) United States
(12) Patent Application Publication
(10) Pub. No.: US 2005/0201647 A1
(43) Pub. Date: Sep. 15, 2005

(54) Half plain bearing

(75) Inventors: Koji Kuroda, Inuyama (JP); Arihiro Kimura, Inuyama (JP); Akira Onda, Inuyama (JP); Atsushi Okado, Inuyama (JP); Masaaki Sakamoto, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Company Ltd., Naka-ku (JP)

(21) Appl. No.: 11/077,030

(22) Filed: Mar. 11, 2005

(30) Foreign Application Priority Data
Mar. 11, 2004 (JP) 2004-068294

(51) Int. Cl. F16C 32/06; F16C 33/10

(52) U.S. Cl. 384/291

(57) ABSTRACT

A half plain bearing which can minimize lubricant leakage while retaining a crush relief function, comprising: grooved portions formed circumferentially on an inner surface of the half plain bearing; protrusions of the grooved portions in a secondary loaded portion being liable to running-in wear caused by contact with a shaft. Consequently, the protrusions undergo running-in wear through contact with the rotating shaft at an early stage. The worn protrusions serve the same purpose as crush reliefs, providing a crush relief function even though no crush relief is formed. This makes it possible to minimize lubricant leakage.

### BACKGROUND OF THE INVENTION

The present invention relates to a half plain bearing which is produced in a form of a half shell so as to form a cylindrical shape when two units of the half plain bearings are combined and which has a plurality of grooved portions formed in the circumferential direction at a predetermined groove pitch on its inner surface.

### DESCRIPTION OF RELATED ART

Conventionally, when half plain beatings produced in the form of a half shell so that a combination of two units will form a cylindrical shape are mounted in a housing, they may not match their ends with each other at parting lines, or if crush height of the half plain bearings is too large, the plain bearings may be deformed near the parting lines of the ends, and swell inward in the radial direction so as to cause local interference with the shaft. Thus, crush reliefs which provide a relief to wall thickness are formed in the axial direction over the whole length of both circumferential ends on the inner surface of the half plain bearings to prevent local interference between the ends of the half plain bearings and the shaft (see, for example, JP-A-5-44729). Incidentally, the crush reliefs are to be provided to correct the local deformations or misalignment which occur at the parting lines of the half plain bearings, and their depth, length, etc. are determined on the basis of housing rigidity, accuracy, and operating conditions.

However, with half plain bearings in which crush reliefs are formed over the ends in the axial direction, such as the half plain bearing disclosed in JP-A-5-44729, there is a problem that lubricant supplied to the half plain bearings can leak in the axial direction through the crush reliefs.

### BRIEF SUMMARY OF THE INVENTION

The present invention has been made in view of the above circumstances and has an object to provide a half plain bearing which can minimize lubricant leakage while retaining a crush relief function.

According to a first aspect of the present invention, there is provided a half plain bearing which is produced in a form of a half shell so as to form a cylindrical shape when two units thereof are combined and which has a plurality of grooved portions formed in a circumferential direction at a predetermined groove pitch on an inner surface of the half plain bearing, wherein tips of protrusions between the above described grooved portions are flat; and wherein a groove pitch p in the above described grooved portions and a size a of the flat portions of the protrusions between the above described grooved portions have following relationships, with respect to a primary loaded portion which is subjected to main load during rotation of a shaft within a predetermined range in a circumferential direction centered on a circumferential center of the half plain bearing and a secondary loaded portion which is subjected to smaller load than the above described primary loaded portion: (a) 0.01 mm≦p≦1.0 mm, (b) 0≦a/p<1.0, and (c) [a/p of the secondary loaded portion] <[a/p of the primary loaded portion].

According to a second aspect of the present invention, there is provided a half plain bearing which is produced in a form of a half shell so as to form a cylindrical shape when two units thereof are combined and which has a plurality of grooved portions formed in a circumferential direction at a predetermined groove pitch on an inner surface of the half plain bearing, wherein tips of protrusions between the above described grooved portions are flat; and wherein a groove pitch p in the above described grooved portions and a size a of flat portions of the protrusions between the above described grooved portions have following relationships, with respect to a primary loaded portion which is subjected to main load during rotation of a shaft within a predetermined range in a circumferential direction centered on a circumferential center of the half plain bearing and a secondary loaded portion which is subjected to smaller load than the above described primary loaded portion: (a) 0.01 mm≦p≦1.0 mm, (b) 0≦a/p<1.0 for the secondary loaded portion and 0<a/p<1.0 for the primary loaded portion, and (c) [a/p of the secondary loaded portion] <[a/p of the primary loaded portion].

According to a third aspect of the present invention, there is provided a half plain bearing which is produced in a form of a half shell so as to form a cylindrical shape when two units thereof are combined and which has a plurality of grooved portions formed in a circumferential direction at a predetermined groove pitch on an inner surface of the half plain bearing, wherein tips of protrusions between the above described grooved portions are flat; and wherein a groove pitch p in the above described grooved portions and a size a of the flat portions of the protrusions between the above described grooved portions have following relationships, with respect to a primary loaded portion which is subjected to main load during rotation of a shaft within a predetermined range in a circumferential direction centered on a circumferential center of the half plain bearing and a secondary loaded portion which is subjected to smaller load than the above described primary loaded portion: (a) 0.01 mm≦p≦1.0 mm, (b) 0≦a/p≦0.4 for the secondary loaded portion and 0<a/p≦0.7 for the primary loaded portion, and (c) [a/p of the secondary loaded portion] ≦[a/p of the primary loaded portion].

In the present invention, depth of the grooved portions may be larger in the above described secondary loaded portion than in the above described primary loaded portion.

Further, in the present invention, crush reliefs may be formed in the axial direction over the whole length of both circumferential ends on the inner surface of the above described half plain bearing.

Also, in the present invention, an oil groove may be formed circumferentially at a substantial middle portion on the inner surface of the half plain bearing substantially symmetrically with respect to the circumferential center and raises of the above described oil groove may be located at a predetermined angle in the circumferential direction from the end of the above described half plain bearing.

Furthermore, in the present invention, an overlay layer may be formed on the inner surface of the half plain bearing.

According to the first aspect, since [a/p of the secondary loaded portion] ≦[a/p of the primary loaded portion], the contact area of the protrusions in the secondary loaded portion is smaller than the contact area of the protrusions in the primary loaded portion, and thus the protrusions in the secondary loaded portion is more liable to running-in wear caused by contact with the shaft. Consequently, the protrusions in the secondary loaded portion, which undergo running-in wear through contact with the rotating shaft at an early stage, serve the same purpose as crush reliefs, providing a crush relief function even though no crush relief is formed. In this case, since the areas which function as crush reliefs are the bare minimum, it is possible to minimize lubricant leakage, as compared to a plain bearing in which crush reliefs are formed positively. Besides, since the grooved portions are formed in the circumferential direction, lubricant leakage in the axial direction can be reduced further. This capability to prevent lubricant leakage makes it possible to reduce the required amount of lubricant and easy to generate a thicker oil film between the half plain bearing and the shaft, which in turn makes it possible to carry larger load imposed by the shaft. Furthermore, the prevention of lubricant leakage results in a sufficient amount of lubricant between the half plain bearing and the shaft, reducing cavitation in the lubricant, and thereby preventing erosion caused by the cavitation on the surface of the half plain bearing.

Also, since [a/p of the secondary loaded portion] ≦[a/p of the primary loaded portion], the area of the flat portion at the tip of the protrusions in the primary loaded portion is larger than the area of the flat portion at the tip of the protrusions in the secondary loaded portion, and thus the contact area with the shaft is larger in the primary loaded portion than in the secondary loaded portion, allowing the primary loaded portion to carry larger load.

Incidentally, the groove pitch 2 is specified within a range of 0.01 mm≦p≦1.0 mm as described above. If the groove pitch p is smaller than 0.01 mm, the cross-sectional area of the grooved portions becomes too small to hold sufficient lubricant. If it exceeds 1.0 mm, the cross-sectional area of the grooved portions becomes too large, reducing a contact portion, i.e., effective pressure area, between the protrusions and the shaft, and resulting in rapid wear.

Also, a/p is specified within a range of 0≦a/p<1.0 as described above. This is because the grooved portions cease to exist unless a/p is smaller than 1.0.

According to the second aspect, since [a/p of the secondary loaded portion] ≦[a/p of the primary loaded portion], the contact area of the protrusions in the secondary loaded portion is smaller than the contact area of the protrusions in the primary loaded portion, and thus the protrusions in the secondary loaded portion is more liable to running-in wear caused by contact with the shaft. Consequently, the protrusions in the secondary loaded portion, which undergo running-in wear through contact with the rotating shaft at an early stage, serve the same purpose as crush reliefs, providing a crush relief function even though no crush relief is formed. In this case, since the areas which function as crush reliefs are the bare minimum, it is possible to minimize lubricant leakage, as compared to a plain bearing in which crush reliefs are formed positively. Besides, since the grooved portions are formed in the circumferential direction, lubricant leakage in the axial direction can be reduced further. This capability to prevent lubricant leakage makes it possible to reduce the required amount of lubricant and easy to generate a thicker oil film between the half plain bearing and the shaft, which in turn makes it possible to carry larger load imposed by the shaft. Furthermore, the prevention of lubricant leakage results in a sufficient amount of lubricant between the half plain bearing and the shaft, reducing cavitation in the lubricant, and thereby preventing erosion caused by the cavitation on the surface of the half plain bearing.

Also, since [a/p of the secondary loaded portion] ≦[a/p of the primary loaded portion], the area of the flat portion at the tip of the protrusions in the primary loaded portion is larger than the area of the flat portion at the tip of the protrusions in the secondary loaded portion, and thus the contact area with the shaft is larger in the primary loaded portion than in the secondary loaded portion, allowing the primary loaded portion to carry larger load.

Incidentally, the groove pitch p is specified within a range of 0.01 mm≦p≦1.0 mm as described above. If the groove pitch p is smaller than 0.01 mm, the cross-sectional area of the grooved portions becomes too small to hold sufficient lubricant. If it exceeds 1.0 mm, the cross-sectional area of the grooved portions becomes too large, reducing a contact portion, i.e., effective pressure area, between the protrusions and the shaft, and resulting in rapid wear.

Also, a/p is specified within a range of 0≦a/p<1.0 for the secondary loaded portion and within a range of 0<a/p<1.0 for the primary loaded portion as described above. This is because the grooved portions cease to exist unless a/p is smaller than 1.0. Since 0≦a/p for the secondary loaded portion, the tips of the protrusions in the secondary loaded portion can be sharp, and thus the secondary loaded portion is liable to running-in wear. On the other hand, since 0<a/p for the primary loaded portion, the protrusions in the primary loaded portion do not have such pointed tips and a flat portion is formed thereon, and thus the primary loaded portion has a large contact area with the shaft, making it possible to carry larger load.

According to the third aspect, since [a/p of the secondary loaded portion] ≦[a/p of the primary loaded portion], the contact area of the protrusions in the secondary loaded portion is smaller than the contact area of the protrusions in the primary loaded portion, and thus the protrusions in the secondary loaded portion is more liable to running-in wear caused by contact with the shaft. Consequently, the protrusions in the secondary loaded portion, which undergo running-in wear through contact with the rotating shaft at an early stage, serve the same purpose as crush reliefs, providing a crush relief function even though no crush relief is formed. In this case, since the areas which function as crush reliefs are the bare minimum, it is possible to minimize lubricant leakage, as compared to a plain bearing in which crush reliefs are formed positively. Besides, since the grooved portions are formed in the circumferential direction, lubricant leakage in the axial direction can be reduced further. This capability to prevent lubricant leakage makes it possible to reduce the required amount of lubricant and easy to generate a thicker oil film between the half plain bearing and the shaft, which in turn makes it possible to carry larger load imposed by the shaft. Furthermore, the prevention of lubricant leakage results in a sufficient amount of lubricant between the half plain bearing and the shaft, reducing cavitation in the lubricant, and thereby preventing erosion caused by the cavitation on the surface of the half plain bearings.

Also, since [a/p of the secondary loaded portion] ≦[a/p of the primary loaded portion], the area of the flat portion at the tip of the protrusions in the primary loaded portion is larger than the area of the flat portion at the tip of the protrusions in the secondary loaded portion, and thus the contact area with the shaft is larger in the primary loaded portion than in the secondary loaded portion, allowing the primary loaded portion to carry larger load.

Incidentally, the groove pitch p is specified within a range of 0.01 mm≦p≦1.0 mm as described above. If the groove pitch p is smaller than 0.01 mm, the cross-sectional area of the grooved portions becomes too small to hold sufficient lubricant. If it exceeds 1.0 mm, the cross-sectional area of the grooved portions becomes too large, reducing a contact portion, i.e., effective pressure area, between the protrusions and the shaft, and resulting in rapid wear.

Also, a/p is specified within a range of 0≦a/p≦0.4 for the secondary loaded portion and within a range of 0≦a/p≦0.7 for the primary loaded portion as described above. Since 0≦a/p≦0.4 for the secondary loaded portion, the protrusions in the secondary loaded portion are pointed, and thus the protrusions in the secondary loaded portion can undergo running-in wear at an early stage. On the other hand, since 0<a/p≦0.7 for the primary loaded portion, the protrusions in the primary loaded portion are not have pointed, and thus the protrusions in the primary loaded portion have a shape suitable for carrying large load. Besides, since the ratio of the protrusion width in the flat portion of the primary loaded portion to the groove pitch is 0.7 or less, the cross-sectional area of the grooved portions is not made smaller than necessary, and thus it is possible to hold a sufficient amount of lubricant.

In the present invention, depth of the grooved portions may be larger in the above described secondary loaded portion than in the above described primary loaded portion. This provides good oil retention and allows much oil to be drawn to the loaded portions. In addition, the protrusions in the secondary loaded portion is lower in strength than the protrusions in the primary loaded portion, causing the protrusions in the secondary loaded portion to undergo running-in wear at an earlier stage.

Further, in the present invention, crush reliefs may be formed in the axial direction over the whole length of both circumferential ends on the inner surface of the half plain bearing. This more effectively prevents any deformation near the parting lines between the ends of the half plain bearings from causing local interference with the shaft.

In the present invention, an oil groove may be formed circumferentially in the substantial middle of the inner surface of the half plain bearing substantially symmetrically with respect to a circumferential center and raises of the oil groove may be located at a predetermined angle in the circumferential direction from the end of the half plain bearing. Since the oil groove is thus formed on the inner circumference of the half plain bearing, it is possible to maintain a sufficient amount of lubricant to form an oil film between the half plain bearings and the shaft. Also, since the raises of the oil groove are located at a predetermined distance from the end of the half plain bearing, it is possible to prevent the lubricant in the oil groove from leaking from the ends of the half plain bearing.

Furthermore, in the present invention, an overlay layer may be formed on the inner surface of the half plain bearing. This makes it possible to improve sliding characteristics of the half plain bearing.

### BRIEF DESCRIPTION OF THE SEVERAL VIEWS OF THE DRAWINGS

FIG. 1 is an exploded perspective view showing relationships between housings and half plain bearings according to an embodiment of the present invention;

FIG. 2 is a sectional view showing how a shaft is supported by the half plain bearings;

FIG. 3 is a sectional view of the half plain bearing;

FIGS. 4 are enlarged sectional views taken along lines A-A and B-B in FIG. 1, where FIG. 4A shows a cross-sectional profile of a grooved portion 4a, FIG. 4B is a B-B sectional view according to a first embodiment of the present invention, FIG. 4C is a B-B sectional view according to a second embodiment of the present invention, and FIG. 4D is a B-B sectional view according to a third embodiment of the present invention;

FIG. 5 is a perspective view of the half plain bearing in which crash reliefs are formed in the axial direction over a whole length of both circumferential ends of an inner surface; and

FIG. 6 is a perspective view of the half plain bearing in which an oil groove is formed circumferentially on the inner surface.

### DETAILED DESCRIPTION OF THE INVENTION

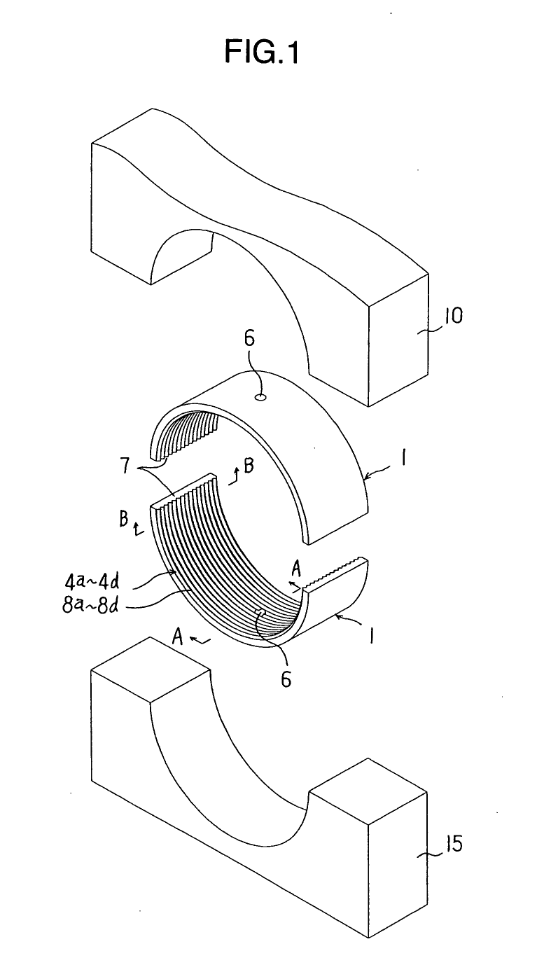

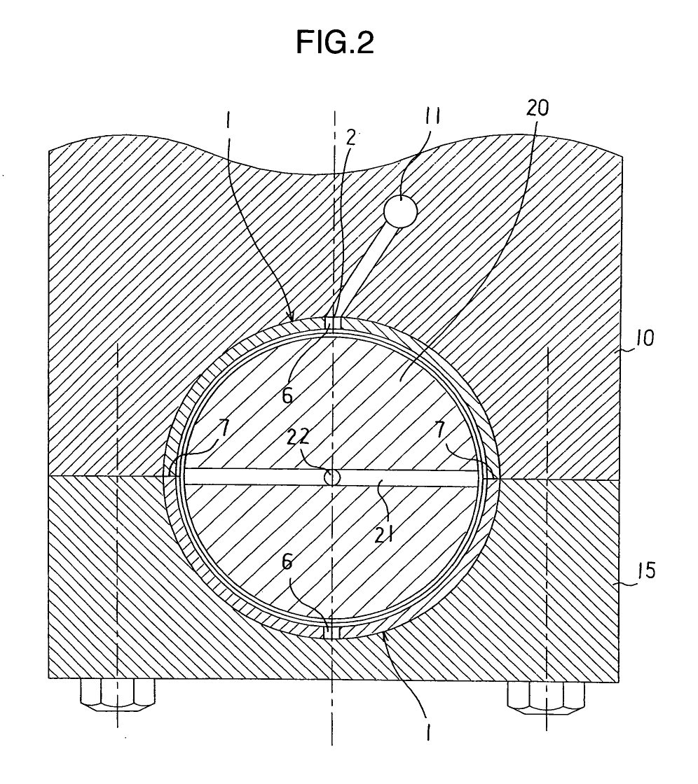

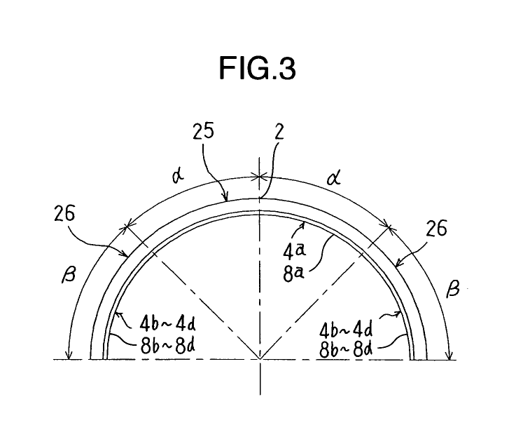

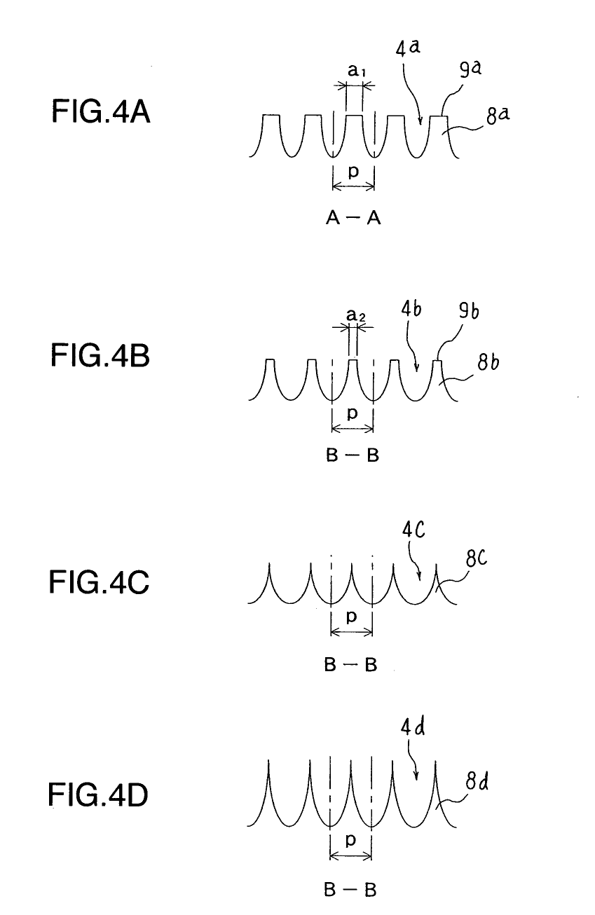

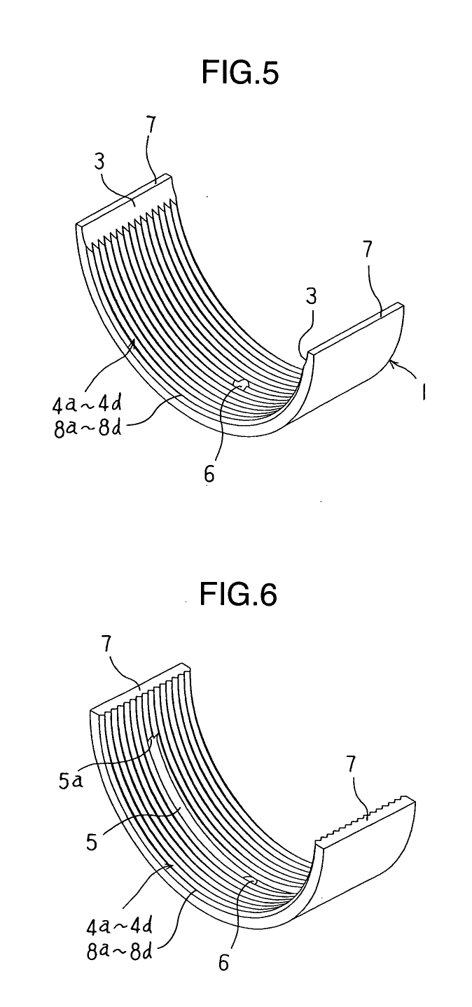

Embodiments according to the present invention will be described below with reference to FIGS. 1 to 6. FIG. 1 is an exploded perspective view showing relationships between housings 10 and 15 and half plain bearings 1. FIG. 2 is a sectional view showing how a shaft 20 is supported by the half plain bearings 1. FIG. 3 is a sectional view of the half plain bearing 1 (hatching is omitted). FIGS. 4 are enlarged sectional views taken along lines A-A and B-B in FIG. 1. FIG. 5 is a perspective view of the half plain bearing 1 in which crash reliefs 3 are formed in the axial direction over a whole length of both circumferential ends 7 of the inner surface. And FIG. 6 is a perspective view of the half plain bearing 1 in which an oil groove 5 is formed circumferentially on the inner surface. Incidentally, the above figures are schematic views of the half plain bearing 1 according to embodiments and some parts are exaggerated or omitted to simplify configuration, structure, etc.

In this embodiment, the half plain bearing 1 used to support a crankshaft and the like in a vehicle engine will be described as an example of the use of the present invention. As seen in FIG. 1, the half plain bearing 1 of the embodiment is formed as a half shell and a combination of two units thereof forms a cylindrical shape to rotatably support a shaft 20 (see FIG. 2). The inner surface of the half plain bearing 1 is lined with, for example, a sliding material made of a copper alloy, aluminum alloy, tin alloy, or lead alloy to satisfy bearing characteristics of half plain bearings 1, such as non-seizing. Also, an overlay layer of tin alloy, lead alloy, or synthetic resin is formed on the inner surface as required. The overlay layer makes it possible to improve sliding characteristics of the half plain bearing.

Also, a plurality of grooved portions 4a to 4d are formed in a circumferential direction at a predetermined groove pitch p on the entire inner surface of the half plain bearing 1. The groove pitch p is specified within a range of 0.01 mm≦p≦1.0 mm. If the groove pitch p is smaller than 0.01 mm, the cross-sectional area of the grooved portions 4a to 4d becomes too small to contain sufficient lubricant. If it exceeds 1.0 mm, the cross-sectional area of the grooved portions 4a to 4d becomes too-large to reduce a contact portion, i.e., effective pressure area, between the protrusions and the shaft, resulting in rapid wear. Incidentally, the grooved portions 4a to 4d are denoted by 4a in a primary loaded portion 25 (see FIG. 3) described later, and by 4b to 4d a secondary loaded portion 26 (see FIG. 3) also described later. Regarding cross-sectional profiles of the grooved portions, the cross-sectional profile of the grooved portion 4a is shown in FIG. 4A and the cross-sectional profiles of the grooved portions 4b to 4d are shown in FIGS. 4B to 4D. Incidentally, FIG. 4B is a B-B sectional view according to a first embodiment, FIG. 4C is a B-B sectional view according to a second embodiment, and FIG. 4D is a B-B sectional view according to a third embodiment. An A-A sectional view shown in FIG. 4A is common among the first to third embodiments.

Now, the primary loaded portion 25 and the secondary loaded portion 26 mentioned above will be described with reference to FIG. 3. The primary loaded portion 25 is the part subjected to main loads during rotation of the shaft 20 supported by the half plain bearings 1. It corresponds to a predetermined circumferential area centered on the circumferential center (denoted by reference numeral 2: on the vertical center line of the half plain bearing 1) of the half plain bearing 1. The primary loaded portion 25 occupies an angular range of α each on the right and left of the circumferential center 2 in the drawing. The angle α is normally in the range of 30 to 60 degrees. The areas outside the primary loaded portion 25 are the secondary loaded portions 26 which are subjected to smaller load than the primary loaded portion 25 and each of which occupies an angular range of β (90 degrees−α). Incidentally, the ranges of the primary loaded portion 25 and the secondary loaded portion 26 do not have to be symmetrical. As shown in FIGS. 4A to 4D, flat portions 9a and 9b are formed, respectively, at the tips of the protrusions 8a and 8b from among the protrusions 8a and 8d of the grooved portions 4a to 4d. In this way, the flat portions 9a and 9b are formed, respectively, at the tips of the protrusions 8a in the primary loaded portion 25 and the tips of the protrusions 8b in the secondary loaded portion 26 according to the first embodiment. An oil supply hole 6 penetrates the intersection between the circumferential center 2 and an approximate axial center of the half plain bearing 1, as shown in FIG. 1, to supply oil into the half plain bearing 1.

The half plain bearings 1 configured as described above are mounted in the housing 10 (e.g., a cylinder block) of the engine and in the housing 15 (e.g., a cap), respectively, as shown in FIG. 1. They form a cylindrical shape when the housing 10 and the housing 15 are combined and then they are assembled in the engine. The shaft (main shaft) 20 is supported by the half plain bearings 1 assembled in the engine via the housings 10 and 15.

When the shaft 20 supported by the half plain bearings 1 rotates, the lubricant sent out from a lubricant supply pump (not shown) is supplied to the half plain bearings 1 through the oil supply hole 6 from an oil hole 11 formed in the housing 10. As the lubricant is supplied to the entire inner surface of the half plain bearings 1, an oil film is formed between the half plain bearings 1 and the shaft 20 to facilitate the smooth rotation of the shaft 20. The lubricant delivered to the oil groove 5 lubricates a plain bearing (not shown) which supports a connecting rod (not shown) after being supplied to it through a first oil path 21 formed across the shaft 20 and a second oil path 22 formed axially in the shaft 20.

The configuration, mounting method, and operation of the half plain bearing 1 have been described above. Next, the grooved portions 4a to 4d which constitute an essential part of the present invention will be described with reference to FIG. 4. Incidentally, in the following description, the width of any flat portions 9a formed on the protrusions in the primary loaded portion 25 is denoted by a₁ and the width of any flat portions 9b formed on the protrusions in the secondary loaded portion 26 is denoted by a₂. The widths a₁ and a₂ are denoted collectively by a.

In the half plain bearing 1 according to the present invention, the relationships between the widths a₁ and a₂ and the groove pitch p are given by 0≦a₁/p<1 and 0≦a₂/p<1. The reason of a₁/p<1 and a₂/p<1 is that the grooved portions 4a and 4b cease to exist unless a₁/p and a₂/p are smaller than 1.0, similarly to the described above. The relationship between a₁/p and a₂/p is a₂/p≦a₁/p. That is, since [a/p of the secondary loaded portion 26] ≦[a/p of the primary loaded portion 25], the contact area of the protrusions 8b to 8d in the secondary loaded portion 26 is smaller than the contact area of the protrusions 8a in the primary loaded portion 25, and thus the secondary loaded portion 26 is more liable to running-in wear caused by contact with the shaft 20. Consequently, the protrusions 8b to 8d, which undergo running-in wear through contact with the rotating shaft 20 at an early stage, serve the same purpose as crush reliefs, providing a crush relief function even though no crush relief is formed. Since the areas which function as crush reliefs are the bare minimum, it is possible to minimize lubricant leakage as compared to a plain bearing in which crush reliefs are formed positively. Besides, since the grooved portions 4a to 4d are formed in the circumferential direction, lubricant leakage in the axial direction can be reduced further. This capability to prevent lubricant leakage makes it possible to reduce the required amount of lubricant and easy to generate a thicker oil film between the half plain bearings 1 and shaft 20, which in turn makes it possible to carry larger loads imposed by the shaft 20. Furthermore, the prevention of lubricant leakage results in a sufficient amount of lubricant between the half plain bearings 1 and shaft 20, reducing cavitation in the lubricant, and thereby preventing erosion of the surfaces of the half plain bearings 1 caused by cavitation.

Also, since a₂/p≦a₁/p, that is, [a/p of the secondary loaded portion 26] ≦[a/p of the primary loaded portion 25], the flat portions 9a of the protrusions 8a in the primary loaded portion 25 are larger in area than the flat portions 9b of the protrusions 8b in the secondary loaded portion 26. Consequently, the primary loaded portion 25 has a larger contact area with the shaft 20 than the secondary loaded portion 26, making it possible to carry larger load.

Looking at the first embodiment of the present invention, in the half plain bearing 1 according to the first embodiment, the flat portions 9a are formed at the tips of the protrusions 8a of the grooved portion 4a in the primary loaded portion 25 (see FIG. 4A) and the flat portions 9b are formed at the tips of the protrusions 8b of the grooved portion 4b in the secondary loaded portion 26 (see FIG. 4B). Since the width a₁ of the flat portions 9a and width a₂ of the flat portions 9b have a relationship a₂<a₁, the protrusions 8b in the secondary loaded portion 26 have a smaller contact area than the protrusions 8a in the primary loaded portion 25, and thus the protrusions 8b in the secondary loaded portion 26 is more liable to running-in wear caused by contact with the shaft 20. Consequently, the protrusions 8b undergo running-in wear through contact with the rotating shaft 20 at an early stage, as described above.

According to the first embodiment described above, the flat portions 9a and 9b are formed, respectively, on the protrusions 8a of the grooved portion 4a in the primary loaded portion 25 and the protrusions 8b of the grooved portion 4b in the secondary loaded portion 26, and now description will be given of the second embodiment in which no flat portion 9b is formed on protrusions 8c of a grooved portion 4c in the secondary loaded portion 26.

Unlike the protrusions 8b of the grooved portion 4b according to the first embodiment, the protrusions 8c of the grooved portion 4c in the secondary loaded portion 26 according to the second embodiment have pointed tips as shown in FIG. 4C instead of flat portions. This is expressed as a₂=0 and a₂/p=0. By not forming a flat portion at the tips of the protrusions 8c, it is possible to subject the protrusions 8c to running-in wear at an earlier stage.

Description has been given above of the second embodiment in which no flat portion is formed on the protrusions 8c of the grooved portion 4c in the secondary loaded portion 26, and the grooved portions 4b and 4c in the secondary loaded portion 26 are equal in depth (e.g., approximately 1.5 pm) to the grooved portion 4a in the primary loaded portion 25 according to both the first and second embodiments. Alternatively, a grooved portion 4d in the secondary loaded portion 26 may be deeper (e.g., approximately 5 μm) than the grooved portion 4a in the primary loaded portion 25 as shown in FIG. 4D (third embodiment). This reduces the strength of the protrusions 8d in the secondary loaded portion 26 compared to the strength of the protrusions 8a in the primary loaded portion 25, causing the protrusions 8d in the secondary loaded portion 26 to undergo running-in wear at an earlier stage. Incidentally, flat portions 9b may be formed at the tips of the protrusions 8d as in the case of the protrusions 8b according to the second embodiment.

When describing the grooved portions 4a to 4d and protrusions 8a to 8d according to the first to third embodiments, it is assumed that 0≦a₁/p<1 in the primary loaded portion 25. Preferably it is, however, 0<a₁/p≦0.7. In that case, the protrusions 8a in the primary loaded portion 25 do not have pointed tips, and thus the protrusions 8a in the primary loaded portion 25 have a shape suitable for carrying large load. Also, when the ratio of the protrusion width in the flat portion 9a to the groove pitch is 0.7 or less, the cross-sectional area of the grooved portion 4a is not made smaller than necessary, and thus it is possible to contain a sufficient amount of lubricant.

Also, it the above description of the first to third embodiments, it is assumed that 0≦a₂/p<1. Preferably it is, however, 0≦a₂/p≦0.4. In that case, the protrusions 8b to 8d in the secondary loaded portion 26 are pointed, and thus the protrusions 8b to 8d in the secondary loaded portion 26 can undergo running-in wear at an earlier stage.

Incidentally, in the first to third embodiments described above, no so-called crush relief is formed on either circumferential end 7 of the inner surface of the half plain bearing 1. However, crush reliefs 3 may be formed as shown in FIG. 5. The crush reliefs 3 are intended to adjust any misalignment at the parting lines on the ends 7 of the half plain bearings 1 or any deformation near the junctures due to excessive crush height of the half plain bearings 1 when two half plain bearings 1 are combined to form a cylindrical shape. Such misalignment or deformation at the parting lines will cause radial swelling, which in turn will cause local interference with the shaft 20. Thus, crush reliefs 3 are formed in advance by cutting recesses in the circumferential ends 7 of the inner surface to prevent the local interference. The crush reliefs 3 gradually become shallower toward the circumferential center 2 of the half plain bearing 1. Incidentally, the depth of the crush reliefs 3 are specified within a range of 0.01 to 0.05 mm. The crush reliefs 3 can effectively prevent deformations near the parting lines on the ends 7 of the half plain bearings 1 from causing local interference with the shaft 20. Incidentally, grooves may be formed on the crush reliefs.

In all the embodiments described above, no so-called oil groove 5 is formed in the circumferential direction on the inner surface of the half plain bearing 1. However, an oil groove 5 may be formed as shown in FIG. 6. The oil groove 5 is intended to supply lubricant between the half plain bearing 1 and the shaft 20 and is formed circumferentially almost in an axially middle portion of the half plain bearing 1. Also, the oil groove 5 has a fixed depth over a predetermined range and has raises 5a at both ends. The raises 5a are circumferentially located at a predetermined angle (e.g., in a range of 0 to 20 degrees) from the ends 7 of the half plain bearing 1. The oil groove 5 makes it possible to supply and maintain a sufficient amount of lubricant to form an oil film between the half plain bearing 1 and the shaft 20. Also, since raises 5a of the oil groove 5 are located at a predetermined distance from the ends 7 of the half plain bearing 1, it is possible to prevent the lubricant in the oil groove 5 from leaking from the ends 7 of the half plain bearing 1.

Although in the first embodiment described above, the flat portions 9a at the tips of the protrusions 8a in the primary loaded portion 25 is larger in width than the flat portions 9b at the tips of the protrusions 8b in the secondary loaded portion 26, this is not restrictive. The flat portions 9a at the tips of the protrusions 8a in the primary loaded portion 25 may be equal in width to the flat portions 9b at the tips of the protrusions 8b in the secondary loaded portion 26. This will make it possible to produce the primary loaded portion 25 and secondary loaded portion 26 in the same machining process, resulting in reduced manufacturing costs.

Also, although in the first to third embodiments described above, the flat portions 9a are formed on the protrusions 8a in the primary loaded portion 25, protrusions 8a without flat portions 9a may be adopted alternatively. In that case, the protrusions 8a in the primary loaded portion 25 will have pointed tips, and thus can undergo running-in wear at an early stage. Also, although the grooves are arc-shaped in cross-sectional profile in FIG. 4, they may be V-shaped.

Also, although the half plain bearing 1 has been described above, citing an example in which it is used to support a crankshaft and the like in a vehicle engine, it can be used not only for vehicle engines, but also for other internal combustion engines.

1. A half plain bearing which is produced in a form of a half shell so as to form a cylindrical shape when two units thereof are combined and which has a plurality of grooved portions formed in a circumferential direction at a predetermined intervals on an inner surface of the half plain bearing,
wherein tips of protrusions between the grooved portions are flat and wherein the predetermined interval p in the grooved portions and a size a of flat portions of the protrusions of the grooved portions have following relationships, with respect to a primary loaded portion which is within a predetermined range in a circumferential direction centered on a circumferential center of the half shell of the half plain bearing and subjected to main loads during rotation of a shaft and a secondary loaded portion which is subjected to smaller loads than the primary loaded portion:
(a) 0.01 mm≦p≦1.0 mm,
(b) 0≦a/p<1.0, and
(c) a/p of the secondary loaded portion≦a/p of the primary loaded portion.

2. The half plain bearing according to claim 1, wherein depth of the grooved portions is larger in the secondary loaded portion than in the primary loaded portion.

3. The half plain bearing according to claim 1, wherein crush reliefs are formed in an axial direction over both circumferential ends of the inner surface of the half plain bearing.

4. The half plain bearing according to claim 1, wherein an oil groove is formed circumferentially almost in the middle of the inner surface of the half plain bearing almost symmetrically with respect a circumferential center and raises of the oil groove are located at a predetermined angle in the circumferential direction from the ends of the half plain bearing.

5. The half plain bearing according to claim 1, wherein an overlay layer is formed on the inner surface of the half plain bearing.

6. A half plain bearing which is produced in a form of a half shell so as to form a cylindrical shape when two units thereof are combined and which has a plurality of grooved portions formed in a circumferential direction at a predetermined intervals on an inner surface of the half plain bearing,
Wherein tips of protrusions between the grooved portions are flat and wherein the predetermined interval p in the grooved portions and a size a of flat portions of the protrusions of the grooved portions have within predetermined ranges in a circumferential direction around a circumferential center of the half cylinder of the half plain bearing following relationships, with respect to a primary loaded portion which is within a predetermined range in a circumferential direction centered on a circumferential center of the half shell of the half plain bearing and subjected to main loads during rotation of a shaft and a secondary loaded portion which is subjected to smaller loads than the primary loaded portion:
(a) 0.01 mm≦p≦1.0 mm,
(b) 0≦a/p<1.0 for the secondary loaded portion and 0<a/p<1.0 for the primary loaded portion, and
(c) a/p of the secondary loaded portion≦a/p of the primary loaded portion.

7. The half plain bearing according to claim 6, wherein depth of the grooved portions is larger in the secondary loaded portion than in the primary loaded portion.

8. The half plain bearing according to claim 6, wherein crush reliefs are formed in an axial direction over both circumferential ends of the inner surface of the half plain bearing.

9. The half plain bearing according to claim 6, wherein an oil groove is formed circumferentially almost in the middle of the inner surface of the half plain bearing almost symmetrically with respect a circumferential center and raises of the oil groove are located at a predetermined angle in the circumferential direction from the ends of the half plain bearing.

10. The half plain bearing according to claim 6, wherein an overlay layer is formed on the inner surface of the half plain bearing.

11. A half plain bearing which is produced in a form of a half shell so as to form a cylindrical shape when two units thereof are combined and which has a plurality of grooved portions formed in a circumferential direction at a predetermined intervals on an inner surface of the half plain bearing,
wherein tips of protrusions between the grooved portions are flat and wherein the predetermined interval p in the grooved portions and a size a of flat portions of the protrusions of the grooved portions have following relationships, with respect to a primary loaded portion which is within a predetermined range in a circumferential direction centered on a circumferential center of the half shell of the half plain bearing and subjected to main loads during rotation of a shaft and a secondary loaded portion which is subjected to smaller loads than the primary loaded portion:
(a) 0.01 mm≦p≦1.0 mm,
(b) 0≦a/p≦0.4 for the secondary loaded portion and 0<a/p≦0.7 for the primary loaded portion, and
(c) a/p of the secondary loaded portion≦a/p of the primary loaded portion.

12. The half plain bearing according to claim 11, wherein depth of the grooved portions is larger in the secondary loaded portion than in the primary loaded portion.

13. The half plain bearing according to claim 11, wherein crush reliefs are formed in an axial direction over both circumferential ends of the inner surface of the half plain bearing.

14. The half plain bearing according to claim 11, wherein an oil groove is formed circumferentially almost in the middle of the inner surface of the half plain bearing almost symmetrically with respect a circumferential center and raises of the oil groove are located at a predetermined angle in the circumferential direction from the ends of the half plain bearing.

15. The half plain bearing according to claim 11, wherein an overlay layer is formed on the inner surface of the half plain bearing.
